(19) United States
(12) Patent Application Publication
(10) Pub. No.: US 2020/0034022 A1
(43) Pub. Date: Jan. 30, 2020

(54) TOUCH DISPLAY APPARATUS AND TOUCH WAKE UP SIGNAL GENERATION METHOD THEREOF

(71) Applicant: Au Optronics Corporation, Hsinchu (TW)

(72) Inventor: Tsung-Hsuan Ho, Hsinchu (TW)

(73) Assignee: Au Optronics Corporation, Hsinchu (TW)

(21) Appl. No.: 16/504,327

(22) Filed: Jul. 7, 2019

(30) Foreign Application Priority Data
Jul. 27, 2018 (TW) 107126054

(51) Int. Cl. G06F 3/041

(52) U.S. Cl. CPC G06F 3/04184; G06F 3/04166

(57) ABSTRACT

A touch display apparatus and a touch wake up signal generation method thereof are provided. The touch display apparatus includes a touch display panel, a time controller and a source driver. The touch wake up signal generation method includes: reading a wake up protocol information and starting a wake up mechanism according to the wake up protocol information, transmitting a touch wake up signal by a plurality of source lines of the touch display apparatus during a vertical blanking interval when the wake up mechanism is started, wherein the touch wake up signal has a plurality of pulses and each of the plurality of pulses transitions between a first voltage and a second voltage.

### CROSS REFERENCE TO RELATED APPLICATION

This application claims the priority benefit of Taiwan application serial no. 107126054, filed on Jul. 27, 2018. The entirety of the above-mentioned patent application is hereby incorporated by reference herein and made a part of specification.

### BACKGROUND OF THE INVENTION

### Field of the Invention

The disclosure relates to a touch display apparatus and a touch wake up signal generation method thereof, and more particularly, to a touch display apparatus and a touch wake up signal generation method thereof that prevents the picture quality of the touch display apparatus from being affected by a touch wake up signal.

### Description of Related Art

In recent years, active electrostatic solution (AES) have been used on active styluses to improve the screen edge accuracy and to reduce parallax. However, active styluses with AES technology must be used in conjunction with a power supply. In general, it is not desirable to configure a power switch on the active stylus. For the purpose of power saving, most manufacturers perform a wake up action by outputting a touch wake up signal at regular intervals through the transmission (TX) line of the touch display panel.

Moreover, since the touch display apparatus using AES technology simultaneously outputs a peak-to-peak touch wake up signal of up to 9 volts in each touch transmission line and with such powerful signal not in sync with the display data of the touch display apparatus, a lot of noise interferences inadvertently affect the picture quality of the touch display apparatus and create horizontal scrolling stripes problems. Therefore, ways to prevent the noise interferences of the touch wake up signal from affecting the image quality of the touch display apparatus has become an important topic.

### SUMMARY OF THE INVENTION

A touch display apparatus and a touch wake up signal generation method thereof to prevent the picture quality of the touch display apparatus from being affected by an output of a touch wake up signal are provided.

A touch wake up signal generation method of the disclosure is adapted for a touch display apparatus. The touch wake up signal generation method includes: reading a wake up protocol information, starting a wake up mechanism according to the wake up protocol information, and transmitting a touch wake up signal by a plurality of source lines of the touch display apparatus during a vertical blanking interval when the wake up mechanism is started, wherein the touch wake up signal has a plurality of pulses and each of the plurality of pulses transitions between a first voltage and a second voltage.

A touch display apparatus of the disclosure includes a touch display panel, a time controller and a source driver. The time controller reads a wake up protocol information, starts a wake up mechanism according to the wake up protocol information, and generates a control signal when the wake up mechanism is started. The source driver is coupled to the time controller and the touch display panel. The source driver receives the control signal and transmits a touch wake up signal to a plurality of source lines of the touch display apparatus according to the control signal during a vertical blanking interval, wherein the touch wake up signal has a plurality of pulses, and each of the plurality of pulses transitions between a first voltage and a second voltage.

Based on the above, the time controller receives and reads the wake up protocol information and starts the wake up mechanism of the touch display apparatus according to the wake up protocol information. The time controller controls the source driver when the wake up mechanism is started, such that the touch wake up signal is transmitted to the plurality of source lines of the touch display apparatus during the vertical blanking interval. Since the touch wake up signal is transmitted to the plurality of source lines during the vertical blanking interval, the plurality of source lines are not required to send the touch wake up signal during the active display interval, thus the display function of the touch display apparatus is maintained, and the touch wake up signal does not affect the picture quality of the touch display apparatus.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a touch display apparatus adapted for a touch wake up signal generation method according to an embodiment of the disclosure.

FIG. 2 is a schematic view of a touch display panel of the touch display apparatus according to the embodiment of FIG. 1 of the disclosure.

FIG. 3 is a schematic timing diagram of a touch wake up signal according to the embodiment of FIG. 1 of the disclosure.

FIG. 4 is a schematic waveform diagram of a touch wake up signal during a vertical blanking interval according to the embodiment of FIG. 1 of the disclosure.

FIG. 5 is a schematic view of a touch display apparatus according to another embodiment of the disclosure.

FIG. 6 is a schematic timing diagram of a touch wake up signal according to the embodiment of FIG. 5 of the disclosure.

FIG. 7 is a flowchart of a touch wake up signal generation method according to an embodiment of the disclosure.

### DESCRIPTION OF THE EMBODIMENTS

Embodiments of the invention are provided as follows. It should be noted that the reference numerals and part of the contents of the previous embodiment are used in the following embodiments, in which identical reference numerals indicate identical or similar components, and repeated description of the same technical contents is omitted. Please refer to the description of the previous embodiment for the omitted contents, which will not be repeated hereinafter.

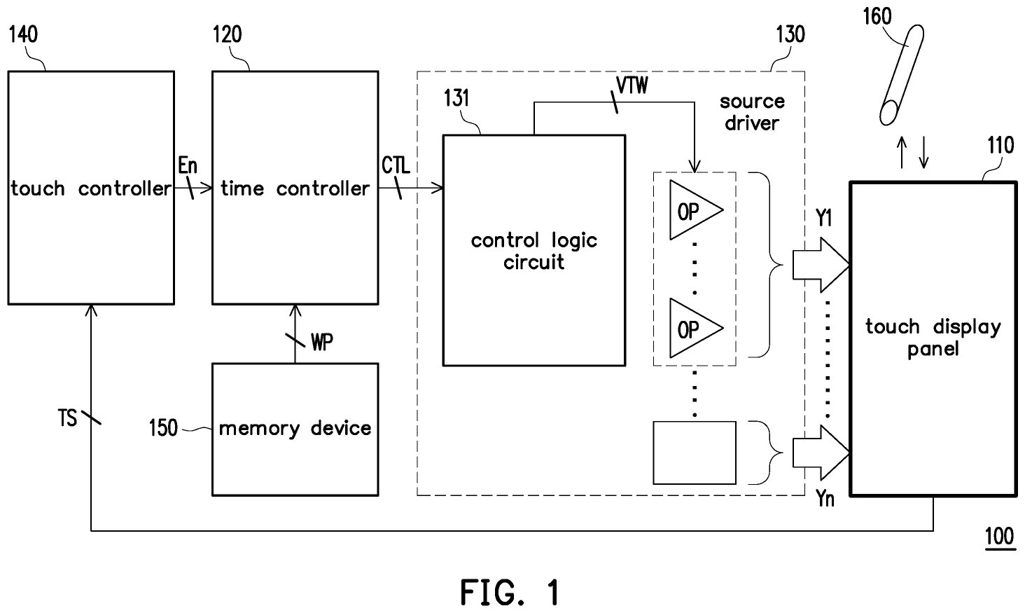

Referring to FIG. 1, FIG. 1 is a schematic view of a touch display apparatus adapted for a touch wake up signal generation method according to an embodiment of the disclosure. A touch display apparatus 100 of this embodiment includes a touch display panel 110, a time controller 120, a source driver 130, a touch controller 140, a memory device 150 and an active touch medium 160.

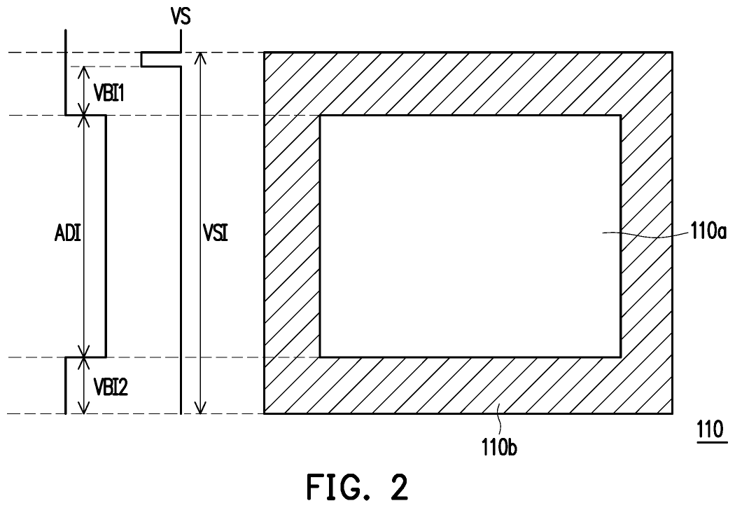

Herein, referring to FIG. 2, FIG. 2 is a schematic view of a touch display panel of the touch display apparatus according to the embodiment of FIG. 1 of the disclosure. The touch display panel 110 in the touch display apparatus 100 includes an active display area 110a and a virtual display area 110b. When the touch display panel 110 performs a touch display operation, a vertical scanning interval VSI is activated according to a vertical synchronization signal VS during a screen period so as to perform a scanning action to the active display area 110a and the virtual display area 110b of the touch display panel 110. In addition, in the vertical scanning interval VSI, there are a vertical blanking interval VBI1, a vertical blanking interval VBI2 and an active display interval ADI, wherein the vertical blanking interval VBI1, the active display interval ADI and the vertical blanking interval VBI2 are generated in sequence. In this embodiment of the disclosure, the touch wake up signal VTW is transmitted to a plurality of source lines of the touch display apparatus 100 during the vertical blanking interval VBI1 and the vertical blanking interval VBI2. As such, the plurality of source lines are not required to transmit the touch wake up signal VTW during the active display interval ADI, and the display function of the touch display apparatus 100 is maintained thereby.

Still referring to FIG. 1 and FIG. 2, in this embodiment, the time controller 120 reads a wake up protocol information WP, starts a wake up mechanism of the touch display apparatus 100 according to the wake up protocol information WP, and generates a control signal CTL to a source driver 130 when the wake up mechanism is started to control the source driver 130. It should be noted herein that, the timing provided by the time controller 120 may be defined by the designer or the user, and the disclosure is not intended to limit the timing.

The source driver 130, coupled to the time controller 120 and the touch display panel 110, receives the control signal CTL of the time controller 120, and according to the control signal CTL, transmits the touch wake up signal VTW to the plurality of source lines of the touch display apparatus 100 during the vertical blanking interval VBI1 and the vertical blanking interval VBI2. In detail, the source driver 130 includes a control logic circuit 131 and a plurality of output channels Y1 to Yn, the control logic circuit 131 is coupled to the plurality of output channels Y1 to Yn, wherein each of the plurality of output channels Y1 to Yn is, for example, constructed by an output buffer OP. In other words, the source driver 130 of this embodiment receives the control signal CTL from the time controller 120, sends the touch wake up signal VTW through the plurality of output channels Y1 to Yn according to the control signal CTL during the vertical blanking interval VBI1 and the vertical blanking interval VBI2. The touch wake up signal VTW is transmitted to the touch display panel 110 through the plurality of source lines.

The touch controller 140 is adapted to detect whether a touch signal TS is received, after the wake up mechanism of the touch display apparatus 100 is started and touch signal TS is sent by the active touch medium 160 to the touch display panel 110. The memory device 150 is coupled to the time controller 120 and is adapted to store the wake up protocol information WP, wherein the memory device 150 is, for example, a read-only memory (ROM), an electrically-erasable programmable read-only memory (EEPROM), a flash memory or other storage medium well known to those skilled in the art, the disclosure is not limited thereto.

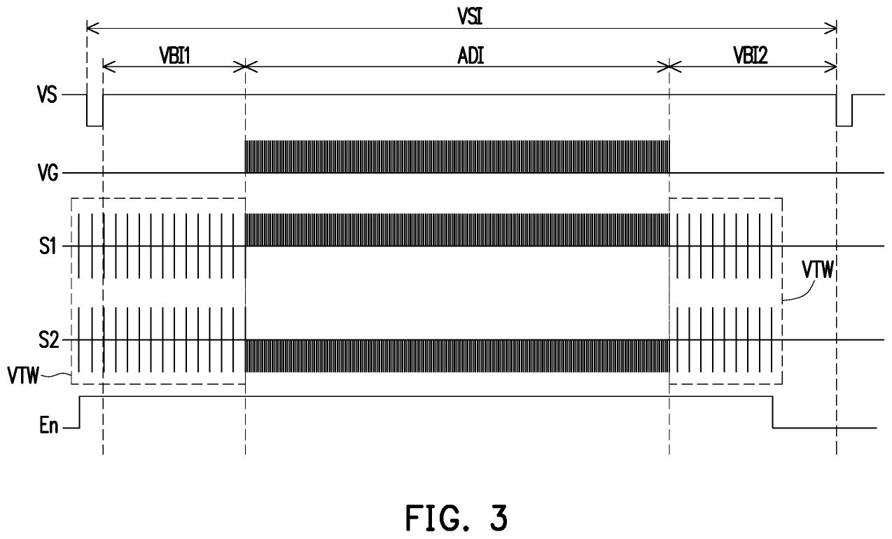

The mechanics between and of various components of the touch display apparatus 100 are described herein. Referring to both FIG. 1 and FIG. 3, FIG. 3 is a schematic timing diagram of a touch wake up signal according to the embodiment of FIG. 1 of the disclosure. When the display function of the touch display apparatus 100 is started, the time controller 120 starts the wake up mechanism according to the wake up protocol information WP. In detail, the display function of the touch display apparatus 100 starts when an active touch medium 160 touches the touch display panel 110. Since the touch wake up signal VTW needs to be sent, the time controller 120 receives an enable signal En at an enabled voltage level transmitted by the touch controller 140, receives the wake up protocol information WP stored in the memory device 150, and thereby starts the wake up mechanism of the touch display apparatus 100. In contrast, the display function of the touch display apparatus 100 does not start when the touch display apparatus 100 is not in use. Since the touch wake up signal VTW does not need to be sent, the time controller 120 receives an enable signal En at a disabled voltage level transmitted by the touch controller 140. The time controller 120 does not start the wake up mechanism of the touch display apparatus 100.

The detailed actions after the wake up mechanism of the touch display apparatus 100 is started are described herein. After the wake up mechanism of the touch display apparatus 100 is started, the time controller 120 generates a control signal CTL, and the source driver 130 receives the control signal CTL from the time controller 120. A control logic circuit 131 in the source driver 130 transmits the touch wake up signal VTW to the plurality of source lines of the touch display panel 110 of the touch display apparatus 100 through the plurality of output channels Y1 to Yn according to the control signal CTL during the vertical blanking interval VBI1 and the vertical blanking interval VBI2, and transmits the touch wake up signal VTW to the active touch medium 160. Then, the touch controller 140 detects whether the touch signal TS sent by the active touch medium 160 is received, thereby determines whether the active touch medium 160 is located near the touch display apparatus 100, and performs a touch action to the touch display panel 110.

If the active touch medium 160 is located near the touch display apparatus 100 and touches the touch display panel 110, the active touch medium 160 sends the touch signal TS to the touch display panel 110, and the touch controller 140 receives the touch signal TS from the active touch medium 160. When the touch controller 140 receives the touch signal TS sent by the active touch medium 160, the time controller 120 stops the wake up mechanism of the touch display apparatus 100, and stops the source driver 130 from transmitting the wake up signal VTW, such that the touch display apparatus 100 enters a working mode.

On other hand, as described above, after the wake up mechanism of the touch display apparatus 100 is stopped, and| the touch controller 140 does not receive the touch signal TS sent by the active touch medium 160 during a period of time, the time controller 120 may restart the wake up mechanism of the touch display apparatus 100. In other words, if the touch display apparatus 100 is in the working mode but does not receive the touch signal TS from the active touch medium 160, the active touch medium 160 may be done touching the touch display apparatus 100. As such, the time controller 120 may restart the wake up mechanism of the touch display apparatus 100 and have the source driver 130 resend the wake up signal VTW.

On the other hand, after the wake up mechanism of the touch display apparatus 100 is started and the touch controller 140 continuously does not receive the touch signal TS sent by the active touch medium 160, the time controller 120 starts counting a duration time of the touch controller 140 not receiving the touch signal TS sent by the active touch medium 160. If the duration time is longer than a preset reference time, the active touch medium 160 does not need to and/or does not perform the touch to the touch display panel at this time, hence the time controller 120 stops the wake up mechanism of the touch display apparatus 100 and stops the source driver 130 from transmitting the touch wake up signal VTW, such that the touch display apparatus 100 enters a sleep mode.

It should be noted that a gate drive signal VG, a source drive signal S1 and a source drive signal S2 of this embodiment of the disclosure perform normal display operations during the active display interval ADI; that is, the source drive signal S1 and the source drive signal S2 transmit normal display data, and the gate drive signal VG transmits a normal scanning signal. On the other hand, during the vertical blanking interval VBI1 and vertical blanking interval VBI2, the source driver 130 transmits the touch wake up signal VTW to the plurality of source lines of the touch display panel 110 according to the control signal CTL of the time controller 120. Since the gate drive signal VG of the touch display panel 110 is at a disabled voltage level; in other words, all gate lines are turned off during the vertical blanking interval VBI1 and the vertical blanking interval VBI2, so the touch wake up signal VTW output through each of the plurality of source lines does not affect the picture quality of the touch display apparatus 100.

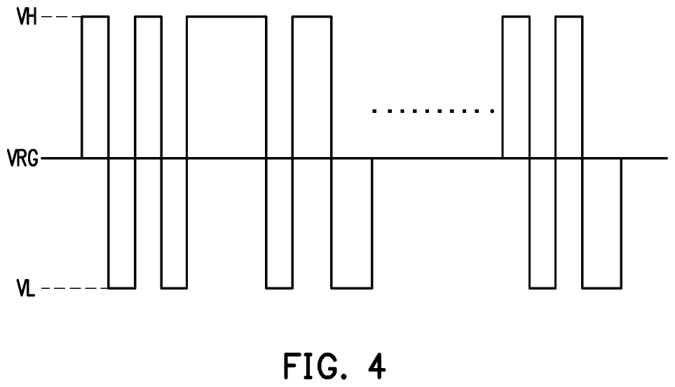

Referring to FIG. 1, FIG. 3 and FIG. 4, FIG. 4 is a schematic waveform diagram of a touch wake up signal during a vertical blanking interval according to the embodiment of FIG. 1 of the disclosure. The signal waveform of the touch wake up signal VTW of this embodiment during the vertical blanking interval VBI1 and the vertical blanking interval VBI2 may be as shown in FIG. 4. In this embodiment, the touch wake up signal VTW has a plurality of pulses, and each of the plurality of pulses transitions between a first voltage VH and a second voltage VL. Specifically, each of the plurality of pulses of the touch wake up signal VTW is formed by the first voltage VH and the second voltage VL performing one or more transitions with reference to the ground voltage VRG, wherein the first voltage VH is greater than the reference ground voltage VRG, and the second voltage VL is smaller than the reference ground voltage VRG. Accordingly, in this embodiment of the disclosure, the touch wake up signal VTW is transmitted to each of the plurality of source lines of the touch display apparatus 100 by the source driver 130 during the vertical blanking interval VBI1 and the vertical blanking interval VBI2. As such, each of the plurality of source lines are not required to transmit the touch wake up signal VTW during the active display interval ADI, so the display function of the touch display apparatus 100 is maintained thereby, and the touch wake up signal VTW does not affect the picture quality of the touch display apparatus 100.

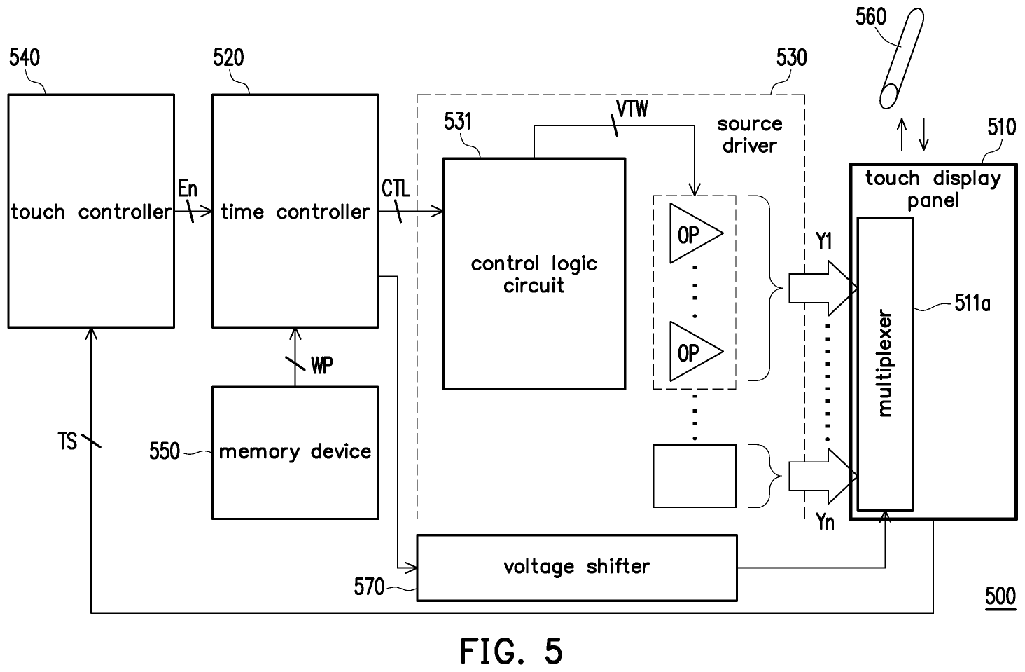

Referring to FIG. 5, FIG. 5 is a schematic view of a touch display apparatus according to another embodiment of the disclosure. A touch display apparatus 500 of this embodiment includes a touch display panel 510, a time controller 520, a source driver 530, a touch controller 540, a memory device 550 and an active touch medium 560. Herein, the source driver 530 includes a control logic circuit 531 and a plurality of output channels Y1 to Yn, the control logic circuit 531 is coupled to the plurality of output channels Y1 to Yn. The difference between this embodiment and the embodiment of FIG. 1 is that, the touch display apparatus 500 of this embodiment further includes a voltage shifter 570 and a multiplexer 511a disposed in the touch display panel 510. It should be noted herein that, in order to simplify the description, only the multiplexer 511a is shown in this embodiment. However, the single multiplexer in the touch display panel 510 includes a plurality of multiplexer circuits. Therefore, the disclosure is not intended to limit the number of multiplexers in the touch display apparatus 500. The voltage shifter 570 is coupled between the time controller 520 and the touch display panel 510. The multiplexer 511a is coupled to the source driver 530.

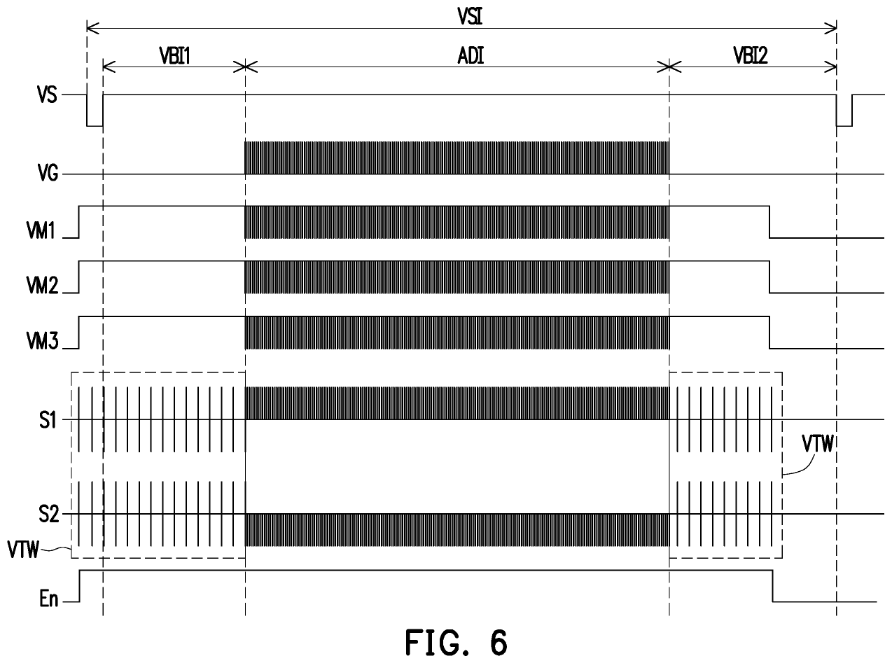

Herein, also referring to FIG. 6, FIG. 6 is a schematic timing diagram of a touch wake up signal according to the embodiment of FIG. 5 of the disclosure. It should be noted that, the gate drive signal VG, the source drive signal S1, the source drive signal S2, a switch signal VM1, a switch signal VM2 and a switch signal VM3 of this embodiment of the disclosure perform normal display operations during the active display interval ADI. After the wake up mechanism of the touch display apparatus 500 is started, the time controller 520 generates a control signal CTL to the source driver 530, such that the source driver 530 transmits the touch wake up signal VTW to the plurality of source lines of the touch display panel 510 of the touch display apparatus 500 according to the control signal CTL during the vertical blanking interval VBI1 and the vertical blanking interval VBI2. At the same time, the time controller 520 generates a turn-on signal to the voltage shifter 570, the voltage shifter 570 receives the turn-on signal from the time controller 520 to offset the voltage level of the turn-on signal, and transmits the switch signal VM1, the switch signal VM2 and the switch signal VM3, which are generated after offsetting the voltage level of the turn-on signal, to the multiplexer 511a during the vertical blanking interval VBI1 and the vertical blanking interval VBI2, such that a plurality of switches in the multiplexer 511a are all turned on.

In other words, during the vertical blanking interval VBI1 and the vertical blanking interval VBI2, the time controller 520 of this embodiment not only controls the source driver 530 to output the touch wake up signal VTW, but also outputs the turn-on signal to the voltage shifter 570, such that the voltage shifter 570 generates the switch signal VM1, the switch signal VM2 and the switch signal VM3 according to the turn-on signal to turn on a plurality of switches in the multiplexer 511a. As such, the multiplexer 511a of the touch display panel 510 may output touch wake up signal VTW through respective paths of the plurality of switches, and the touch controller 540 may receive the touch signal TS through the respective paths of the plurality of switches in the multiplexer 511 when the active touch medium 560 touches the display panel 510.

The mechanics between and of various components of the touch display apparatus 500 are similar to the mechanics between and of the various components of the touch display apparatus 100 of the embodiment of FIG. 1, and details are not described hereinafter.

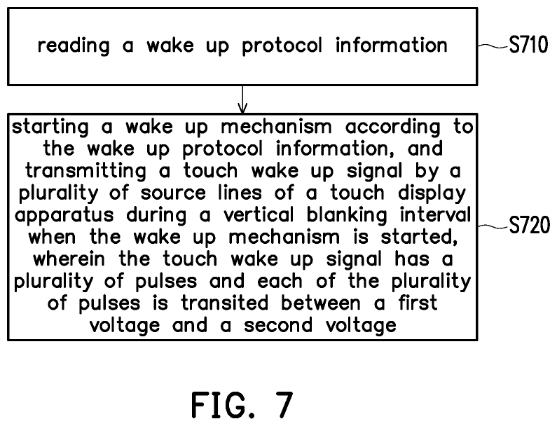

Referring to FIG. 7, FIG. 7 is a flowchart of a touch wake up signal generation method according to an embodiment of the disclosure. In step S710, a time controller reads a wake up protocol information. In step S720, a wake up mechanism is started according to the wake up protocol information, and a touch wake up signal is transmitted by a plurality of source lines of a touch display apparatus during a vertical blanking interval when the wake up mechanism is started, wherein the touch wake up signal has a plurality of pulses and each of the plurality of pulses transitions between a first voltage and a second voltage.

Implementation details of step S710 to step S720 have been specified in the foregoing embodiments and examples of the disclosure and thus are not repeated hereinafter.

In summary, the disclosure may start the wake up mechanism of the touch display apparatus by the time controller receiving and reading the wake up protocol information, and may control the source driver to transmit the touch wake up signal to the plurality of source lines of the touch display apparatus during the vertical blanking interval. As such, each of the plurality of source lines is not required to transmit the touch wake up signal during the active display interval, so the display function of the touch display apparatus is maintained thereby, and the touch wake up signal does not affect the picture quality of the touch display apparatus.

It will be apparent to those skilled in the art that various modifications and variations can be made to the disclosed embodiments without departing from the scope or spirit of this disclosure. In view of the foregoing, it is intended that the disclosure covers modifications and variations provided that they fall within the scope of the following claims and their equivalents.

What is claimed is:

1. A touch wake up signal generation method adapted for a touch display apparatus, comprising:
reading a wake up protocol information;
starting a wake up mechanism according to the wake up protocol information; and
transmitting a touch wake up signal by a plurality of source lines of the touch display apparatus during a vertical blanking interval when the wake up mechanism is started, wherein
the touch wake up signal has a plurality of pulses, and each of the plurality of pulses transitions between a first voltage and a second voltage.

2. The touch wake up signal generation method according to claim 1, further comprising:
turning on a plurality of switches in an at least one multiplexer in the touch display apparatus during the vertical blanking interval after the wake up mechanism is started.

3. The touch wake up signal generation method according to claim 1, further comprising:
transmitting the touch wake up signal to an active touch medium after the wake up mechanism is started.

4. The touch wake up signal generation method according to claim 3, further comprising:
after the wake up mechanism is started, detecting whether a touch signal sent by the active touch medium is received; and
if the touch signal sent by the active touch medium is received, stopping the wake up mechanism and stopping the plurality of source lines of the touch display apparatus from transmitting the touch wake up signal.

5. The touch wake up signal generation method according to claim 4, further comprising:
after the wake up mechanism is stopped, if the touch signal sent by the active touch medium is not received, restarting the wake up mechanism.

6. The touch wake up signal generation method according to claim 3, further comprising:
after the wake up mechanism is started, detecting whether a touch signal sent by the active touch medium is received; and
if a duration time of not receiving the touch signal sent by the active touch medium is longer than a preset reference time, stopping the wake up mechanism and stopping the plurality of source lines of the touch display apparatus from transmitting the touch wake up signal.

7. The touch wake up signal generation method according to claim 1, further comprising:
when the display function of the touch display apparatus is started, starting the wake up mechanism according to the wake up protocol information.

8. The touch wake up signal generation method according to claim 1, wherein the first voltage is greater than a reference ground voltage, and the second voltage is smaller than the reference ground voltage.

9. A touch display apparatus, comprising:
a touch display panel;
a time controller, starting a wake up mechanism according to a wake up protocol information, and generating a control signal when the wake up mechanism is started;
a source driver, coupled to the time controller and the touch display panel, receiving the control signal, and transmitting a touch wake up signal to a plurality of source lines of the touch display apparatus according to the control signal during a vertical blanking interval,
wherein the touch wake up signal has a plurality of pulses, and each of the plurality of pulses transitions between a first voltage and a second voltage.

10. The touch display apparatus according to claim 9, further comprising:
an at least one multiplexer coupled to the source driver,
wherein after the wake up mechanism is started, the time controller turns on a plurality of switches in the at least one multiplexer during the vertical blanking interval.

11. The touch display apparatus according to claim 9, wherein the touch wake up signal is transmitted to an active touch medium after the wake up mechanism is started.

12. The touch display apparatus according to claim 11, further comprising:
a touch controller, adapted for detecting whether a touch signal sent by the active touch medium is received after the wake up mechanism is started.

13. The touch display apparatus according to claim 12, wherein if the touch controller receives the touch signal sent by the active touch medium, the time controller stops the wake up mechanism and stops the source driver from transmitting the wake up signal.

14. The touch display apparatus according to claim 13, wherein after the wake up mechanism is stopped, if the touch controller does not receive the touch signal sent by the active touch medium, the time controller restarts the wake up mechanism.

15. The touch display apparatus according to claim 13, wherein after the wake up mechanism is started, if a duration time of the touch controller not receiving the touch signal sent by the active touch medium is longer than a preset reference time, the time controller stops the wake up mechanism and stops the source driver from transmitting the wake up signal.

16. The touch display apparatus according to claim 9, wherein when the display function of the touch display apparatus is started, the time controller starts the wake up mechanism according to the wake up protocol information.

17. The touch display apparatus according to claim 9, wherein the first voltage is greater than a reference ground voltage, and the second voltage is smaller than the reference ground voltage.

18. The touch display apparatus according to claim 9, further comprising:
a memory device coupled to the time controller and adapted for storing the wake up protocol information.
